(19) United States
(12) Patent Application Publication
(10) Pub. No.: US 2026/0088990 A1
(43) Pub. Date: Mar. 26, 2026

(54) NETWORK EVENT MEASUREMENTS USING CRYPTOGRAPHY AND A TRUSTED EXECUTION ENVIRONMENT

(71) Applicant: Google LLC, Mountain View, CA (US)

(72) Inventors: Subhakanta Kar, Sammamish, WA (US); Sriram Srinivasan, Redmond, WA (US)

(21) Appl. No.: 19/261,263

(22) Filed: Jul. 7, 2025

(30) Foreign Application Priority Data
Sep. 23, 2024 (IN) 202411071836

(51) Int. Cl. H04L 9/08

(52) U.S. Cl. CPC H04L 9/0877; H04L 9/0822

(57) ABSTRACT

Methods, systems, and apparatus, including computer programs encoded on a computer storage medium, for correlating data for user network events in a secure and privacy preserving manner. In one aspect, a method includes receiving, by a secure network measurement system comprising a trusted execution environment (TEE) and from a first device, presentation data for a presentation of a digital component at the first device. The presentation data includes an encrypted first identifier. The encrypted first identifier is generated by encrypting a first identifier that identifies a user of the first device using a first encryption key. The system receives, from a second device, network event data sent in response to a user of the second device performing a specified action following the presentation of the digital component at the first device. The network event data includes an encrypted second identifier.

### CROSS-REFERENCE TO RELATED APPLICATION

This application claims the benefit under 35 U.S.C. § 119 of IN patent application Ser. No. 20/241,1071836 filed on Sep. 23, 2024. The disclosure of the foregoing application is incorporated herein by reference in its entirety for all purposes.

### BACKGROUND

This specification relates to cryptography and trusted execution environments (TEEs) for measuring network events in ways that enhance data security and preserve user privacy.

Data security and user privacy are vital in systems and devices connected to public networks, such as the Internet. The enhancement of user privacy has led many developers to change the ways in which user data is handled. For example, some browsers are planning to deprecate the use of third-party cookies that enable entities to track the online activity of users across multiple sites.

### SUMMARY

In general, one innovative aspect of the subject matter described in this specification can be embodied in methods that include the actions of receiving, by a secure network measurement system including a trusted execution environment (TEE) and from a first device, presentation data for a presentation of a digital component at the first device, the presentation data including an encrypted first identifier, where the encrypted first identifier is generated by encrypting a first identifier that identifies a user of the first device using a first encryption key; receiving, by the secure network measurement system and from a second device, network event data sent in response to a user of the second device performing a specified action following the presentation of the digital component at the first device, the network event data comprising an encrypted second identifier, where the encrypted second identifier is generated by encrypting a second identifier that identifies the user of the second device using a second encryption key; matching, within the TEE, the presentation data with the network event data to form a presentation-network event pair; and determining a network event measurement for the digital component based on a plurality of presentation-network event pairs including a presentation-network event pair stored in a database. Other implementations of this aspect include corresponding apparatus, systems, and computer programs, configured to perform the aspects of the methods, encoded on computer storage devices.

These and other embodiments can each optionally include one or more of the following features. In some aspects, the first encryption key is different from the second encryption key. A key generator can generate the keys. The key generator can generate a first decryption key for decrypting data encrypted using the first encryption key. The key generator can generate a second decryption key for decrypting data encrypted using the second encryption key. Aspects can also include decrypting the first identifier with the first decryption key and decrypting the second identifier with the second decryption key. The matching can be based on a comparison of the first identifier with the second identifier.

In some aspects, the second encryption key is the same as the first encryption key. In such aspects, the first identifier and the second identifier are decrypted with the decryption key. In such aspects, matching the presentation data with the network event data is based on a comparison of the first identifier with the second identifier.

In some aspects, the first identifier or the second identifier includes at least one of a user identifier, an email address, physical address, a postal address, a MAC address of the first device, or an IP address associated with the first device.

Particular embodiments of the subject matter described in this specification can be implemented so as to realize one or more of the following advantages. The methods and systems described herein help protect user privacy and data security by encrypting identifiers that could be used to identify the user when the user's device requests content and/or reports events that occur at the device and decrypting the identifiers for use in determining network event measurements within a trusted execution environment (TEE). Thus, the data identifying the user may only be available in cleartext on the user's device or within a TEE, but otherwise encrypted.

Typically, network event measurements are determined for digital components using third-party cookies that act as a stable and trackable identifier for a user across multiple websites and mobile applications. Multiple entities can correlate network events that can occur at different devices of a user using this stable identifier to determine network event measurements. However, as described above, enhancements in user privacy are leading developers to better protect user data, including cross-site tracking using third-party cookies. The techniques described in this application enable the determination and updating of network event measurements for digital components in the absence of third-party cookies, thereby enabling accurate measurements while also preserving user privacy and data security. For example, rather than send third-party cookies across the Internet, encrypted identifiers are sent, and data related to the encrypted data identifiers is correlated in a TEE to ensure that such data is not attributable to the individual users outside of the TEE. This prevents the users from being tracked across multiple websites and applications using stable identifiers.

Additionally, network data for an individual user can be sent along different paths to the TEE and the data along each path can be encrypted using a different encryption key, e.g., a different public key. The TEE can store the decryption keys (e.g., private keys corresponding to the public keys) to decrypt the data within the TEE and correlate data for individual users within the TEE. This prevents entities from combining their data for individual users outside the TEE to learn additional information about the users. For example, using the different paths and different encryption along the different paths prevents entities from correlating information sent along the different paths with users, e.g., since the encrypted values would be different. In particular, if the same encryption key was used to encrypt an identifier, the encrypted identifiers would be the same along both paths and could be used to correlate events sent along the different paths. The TEE can help improve processing speed since it can be easily scaled up in the cloud while still restricting the output data to satisfy minimum thresholds for privacy.

Thus, the described systems and techniques enable cross-domain and cross-device network measurements in secure and privacy preserving manners without the use of third-party cookies.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which network events are measured while preserving data privacy and security.

FIG. 2 is a block diagram that illustrates some interactions between components of the environment of FIG. 1.

FIG. 3 is a diagram that illustrates some interactions between components of the environment of FIG. 1.

FIG. 4 is a diagram that illustrates some interactions between components of the environment of FIG. 1.

FIG. 5 a flow chart of an example process of measuring network event data for digital components.

FIG. 6 illustrates an electronic device.

Like reference numbers and designations in the various drawings indicate like elements.

### DETAILED DESCRIPTION

This specification describes techniques for correlating (e.g., matching) data for user network events, e.g., events that occur on the same or different electronic devices, of a particular individual without revealing identifiers that can be used to identify the individual in cleartext outside of a trusted execution environment (TEE). When an event occurs, the device that detects the event can encrypt an identifier for the individual using an encryption key (or otherwise obtain the encrypted identifier) and either send the network event data along with the encrypted identifier to the TEE of a secure network measurement system or store the data in a database accessible by the TEE. The TEE can be configured to match data for individual users by decrypting the encrypted identifiers within the TEE using decryption keys. To prevent entities from correlating data using the ciphertext of encrypted identifiers, the identifiers for individuals can be encrypted using different keys to report different network events or based on the entity reporting the network event. In this way, only the TEE can correlate different encrypted identifiers for the same individual within the TEE.

A TEE provides a secure environment for computation and is sometimes implemented as a secure area of a main processor. A TEE can guarantee that code and data loaded inside the TEE are protected with respect to integrity and confidentiality. Integrity indicates that unauthorized entities cannot alter code and/or data within the TEE, and confidentiality indicates that unauthorized entities cannot read code and/or data within the TEE.

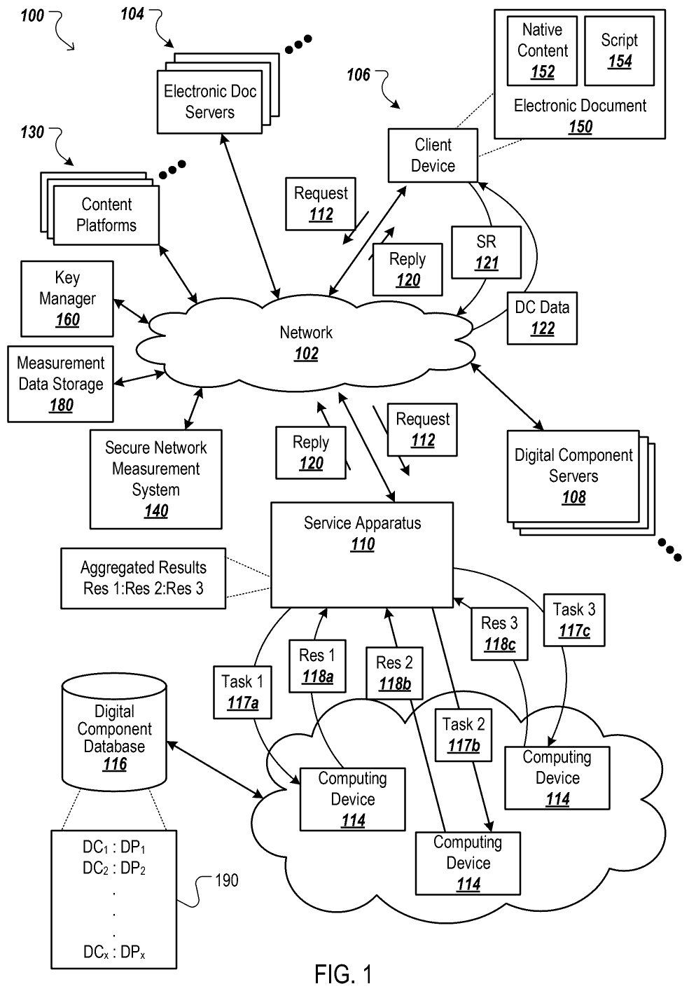

FIG. 1 is a block diagram of an example environment 100 in which network events are measured while preserving data privacy and security. The example environment 100 includes a network 102, such as a local area network (LAN), a wide area network (WAN), the Internet, or a combination thereof. The network 102 connects electronic document servers 104, client devices 106, digital component servers 108, a service apparatus 110, content platforms 130, a secure network measurement system 140, a key manager 160, and measurement data storage 180. The example environment 100 may include many different electronic document servers 104, user devices 106, and digital component servers 108.

A client device 106 is an electronic device capable of requesting and receiving online resources over the network 102. Example client devices 106 include personal computers, gaming devices, mobile communication devices, digital assistant devices, augmented reality devices, virtual reality devices, and other devices that can send and receive data over the network 102. A client device 106 typically includes a user application, such as a web browser, to facilitate the sending and receiving of data over the network 102, but native applications (other than browsers) executed by the client device 106 can also facilitate the sending and receiving of data over the network 102.

A gaming device is a device that enables a user to engage in gaming applications, for example, in which the user has control over one or more characters, avatars, or other rendered content presented in the gaming application. A gaming device typically includes a computer processor, a memory device, and a controller interface (either physical or visually rendered) that enables user control over content rendered by the gaming application. The gaming device can store and execute the gaming application locally or execute a gaming application that is at least partly stored and/or served by a cloud server (e.g., online gaming applications). Similarly, the gaming device can interface with a gaming server that executes the gaming application and “streams” the gaming application to the gaming device. The gaming device may be a tablet device, mobile telecommunications device, a computer, or another device that performs other functions beyond executing the gaming application.

Digital assistant devices include devices that include a microphone and a speaker. Digital assistant devices are generally capable of receiving input by way of voice, and respond with content using audible feedback, and can present other audible information. In some situations, digital assistant devices also include a visual display or are in communication with a visual display (e.g., by way of a wireless or wired connection). Feedback or other information can also be provided visually when a visual display is present. In some situations, digital assistant devices can also control other devices, such as lights, locks, cameras, climate control devices, alarm systems, and other devices that are registered with the digital assistant device.

As illustrated, the client device 106 is presenting an electronic document 150. An electronic document 150 is data that presents a set of content at a client device 106. Examples of electronic documents include webpages, word processing documents, portable document format (PDF) documents, images, videos, search results pages, and feed sources. Native applications (e.g., “apps” and/or gaming applications), such as applications installed on mobile, tablet, or desktop computing devices are also examples of electronic documents. Electronic documents can be provided to client devices 106 by electronic document servers 104 (“Electronic Doc Servers”).

For example, the electronic document servers 104 can include servers that host publisher websites. In this example, the client device 106 can initiate a request for a given publisher webpage, and the electronic server 104 that hosts the given publisher webpage can respond to the request by sending machine executable instructions that initiate presentation of the given webpage at the client device 106. Each publisher of a website can have electronic document servers that host its websites.

In another example, the electronic document servers 104 can include app servers from which client devices 106 can download apps. In this example, the client device 106 can download files required to install an app at the client device 106, and then execute the downloaded app locally (i.e., on the client device). Alternatively, or additionally, the client device 106 can initiate a request to execute the app, which is transmitted to a cloud server. In response to receiving the request, the cloud server can execute the application and stream a user interface of the application to the client device 106 so that the client device 106 does not have to execute the app itself. Rather, the client device 106 can present the user interface generated by the cloud server's execution of the app and communicate any user interactions with the user interface back to the cloud server for processing.

Electronic documents can include a variety of content. For example, an electronic document 150 can include native content 152 that is within the electronic document 150 itself and/or does not change over time. Electronic documents can also include dynamic content that may change over time or on a per-request basis. For example, a publisher of a given electronic document (e.g., electronic document 150) can maintain a data source that is used to populate portions of the electronic document. In this example, the given electronic document can include a script, such as the script 154, that causes the client device 106 to request content (e.g., a digital component) from the data source when the given electronic document is processed (e.g., rendered or executed) by a client device 106 (or a cloud server). The client device 106 (or cloud server) integrates the content (e.g., digital component) obtained from the data source into the given electronic document to create a composite electronic document including the content obtained from the data source.

In some situations, a given electronic document (e.g., electronic document 150) can include a digital component script (e.g., script 154) that references the service apparatus 110, or a particular service provided by the service apparatus 110. In these situations, the digital component script is executed by the client device 106 when the given electronic document is processed by the client device 106. Execution of the digital component script configures the client device 106 to generate a request for digital components 112 (referred to as a “component request”), which is transmitted over the network 102 to the service apparatus 110. For example, the digital component script can enable the client device 106 to generate a packetized data request including a header and payload data. The component request 112 can include event data specifying features such as a name (or network location) of a server from which the digital component is being requested, a name (or network location) of the requesting device (e.g., the client device 106), and/or information that the service apparatus 110 can use to select one or more digital components, or other content, provided in response to the request. The component request 112 is transmitted, by the client device 106, over the network 102 (e.g., a telecommunications network) to a server of the service apparatus 110.

As used throughout this document, the phrase “digital component” refers to a discrete unit of digital content or digital information (e.g., a video clip, audio clip, multimedia clip, gaming content, image, text, bullet point, artificial intelligence output, language model output, or another unit of content). A digital component can electronically be stored in a physical memory device as a single file or in a collection of files, and digital components can take the form of video files, audio files, multimedia files, image files, or text files and include advertising information, such that an advertisement is a type of digital component.

The component request 112 can include event data specifying other event features, such as the electronic document being requested and characteristics of locations of the electronic document at which digital component can be presented. For example, event data specifying a reference (e.g., URL) to an electronic document (e.g., webpage) in which the digital component will be presented, available locations of the electronic documents that are available to present digital components, sizes of the available locations, and/or media types that are eligible for presentation in the locations can be provided to the service apparatus 110. Similarly, event data specifying keywords associated with the electronic document (“document keywords”) or entities (e.g., people, places, or things) that are referenced by the electronic document can also be included in the component request 112 (e.g., as payload data) and provided to the service apparatus 110 to facilitate identification of digital components that are eligible for presentation with the electronic document. The event data can also include a search query that was submitted from the client device 106 to obtain a search results page.

Component requests 112 can also include event data related to other information, such as information that a user of the client device has provided, geographic information indicating a state or region from which the component request was submitted, or other information that provides context for the environment in which the digital component will be displayed (e.g., a time of day of the component request, a day of the week of the component request, a type of device at which the digital component will be displayed, such as a mobile device or tablet device). Component requests 112 can be transmitted, for example, over a packetized network, and the component requests 112 themselves can be formatted as packetized data having a header and payload data. The header can specify a destination of the packet and the payload data can include any of the information discussed above.

The service apparatus 110 chooses digital components (e.g., third-party content, such as video files, audio files, images, text, gaming content, augmented reality content, and combinations thereof, which can all take the form of advertising content or non-advertising content) that will be presented with the given electronic document (e.g., at a location specified by the script 154) in response to receiving the component request 112 and/or using information included in the component request 112.

In some implementations, a digital component is selected in less than a second to avoid errors that could be caused by delayed selection of the digital component. For example, delays in providing digital components in response to a component request 112 can result in page load errors at the client device 106 or cause portions of the electronic document to remain unpopulated even after other portions of the electronic document are presented at the client device 106.

Also, as the delay in providing the digital component to the client device 106 increases, it is more likely that the electronic document will no longer be presented at the client device 106 when the digital component is delivered to the client device 106, thereby negatively impacting a user's experience with the electronic document. Further, delays in providing the digital component can result in a failed delivery of the digital component, for example, if the electronic document is no longer presented at the client device 106 when the digital component is provided.

In some implementations, the service apparatus 110 is implemented in a distributed computing system that includes, for example, a server and a set of multiple computing devices 114 that are interconnected and identify and distribute digital component in response to requests 112. The set of multiple computing devices 114 operate together to identify a set of digital components that are eligible to be presented in the electronic document from among a corpus of millions of available digital components (DCI-x). The millions of available digital components can be indexed, for example, in a digital component database 116. Each digital component index entry can reference the corresponding digital component and/or include distribution parameters (DP₁-DPₓ) that contribute to (e.g., trigger, condition, or limit) the distribution/transmission of the corresponding digital component. For example, the distribution parameters can contribute to (e.g., trigger) the transmission of a digital component by requiring that a component request include at least one criterion that matches (e.g., either exactly or with some pre-specified level of similarity) one of the distribution parameters of the digital component.

In some implementations, the distribution parameters for a particular digital component can include distribution keywords that must be matched (e.g., by electronic documents, document keywords, or terms specified in the component request 112) in order for the digital component to be eligible for presentation. Additionally, or alternatively, the distribution parameters can include embeddings that can use various different dimensions of data, such as website details and/or consumption details (e.g., page viewport, user scrolling speed, or other information about the consumption of data). The distribution parameters can also require that the component request 112 include information specifying a particular geographic region (e.g., country or state) and/or information specifying that the component request 112 originated at a particular type of client device (e.g., mobile device or tablet device) in order for the digital component to be eligible for presentation. The distribution parameters can also specify an eligibility value (e.g., ranking score, or some other specified value) that is used for evaluating the eligibility of the digital component for distribution/transmission (e.g., among other available digital components).

The identification of the eligible digital component can be segmented into multiple tasks 117a-117c that are then assigned among computing devices within the set of multiple computing devices 114. For example, different computing devices in the set 114 can each analyze a different portion of the digital component database 116 to identify various digital components having distribution parameters that match information included in the component request 112. In some implementations, each given computing device in the set 114 can analyze a different data dimension (or set of dimensions) and pass (e.g., transmit) results (Res 1-Res 3) 118a-118c of the analysis back to the service apparatus 110. For example, the results 118a-118c provided by each of the computing devices in the set 114 may identify a subset of digital components that are eligible for distribution in response to the component request and/or a subset of the digital component that have certain distribution parameters. The identification of the subset of digital components can include, for example, comparing the event data to the distribution parameters, and identifying the subset of digital components having distribution parameters that match at least some features of the event data.

The service apparatus 110 aggregates the results 118a-118c received from the set of multiple computing devices 114 and uses information associated with the aggregated results to select one or more digital components that will be provided in response to the request 112. For example, the service apparatus 110 can select a set of winning digital components (one or more digital components) based on the outcome of one or more content evaluation processes, as discussed below. In turn, the service apparatus 110 can generate and transmit, over the network 102, reply data 120 (e.g., digital data representing a reply) that enable the client device 106 to integrate the set of winning digital components into the given electronic document, such that the set of winning digital components (e.g., winning third-party content) and the content of the electronic document are presented together at a display of the client device 106.

In some implementations, the client device 106 executes instructions included in the reply data 120, which configures and enables the client device 106 to obtain the set of winning digital components from one or more digital component servers 108. For example, the instructions in the reply data 120 can include a network location (e.g., a Uniform Resource Locator (URL)) and a script that causes the client device 106 to transmit a server request (SR) 121 to the digital component server 108 to obtain a given winning digital component from the digital component server 108. In response to the request, the digital component server 108 will identify the given winning digital component specified in the server request 121 (e.g., within a database storing multiple digital components) and transmit to the client device 106, digital component data (DC Data) 122 that presents the given winning digital component in the electronic document at the client device 106.

Digital component providers can provide digital components for the service apparatus 110 and/or to the digital component servers 108 for distribution to client devices 106. For example, an organization that wants digital components related to an item (e.g., product), service, or event can provide the digital components for distribution by the service apparatus 110. Additionally, the digital component providers can provide distribution parameters for the digital components to the service apparatus 110 for use in selecting the digital components from among digital components received from multiple digital component providers. When the client device 106 receives the digital component data 122, the client device will render the digital component (e.g., third-party content), and present the digital component at a location specified by, or assigned to, the script 154. For example, the script 154 can create a walled garden environment, such as a frame, that is presented within, e.g., besides, the native content 152 of the electronic document 150. In some implementations, the digital component is overlayed over (or adjacent to) a portion of the native content 152 of the electronic document 150, and the service apparatus 110 can specify the presentation location within the electronic document 150 in the reply 120. For example, when the native content 152 includes video content, the service apparatus 110 can specify a location or object within the scene depicted in the video content over which the digital component is to be presented.

A digital component can include a link to a landing page of the digital component provider. Thus, digital component providers can also be considered publishers and the electronic document servers 104 can host the websites that include the landing pages. User interaction with the digital component can cause the client device 106 presenting the digital component to navigate a browser or other application to the linked page.

In some implementations, digital components are distributed to client devices 106 using content platforms 130 which implement functionality of the service apparatus 110. The content platforms 130 can include supply-side platforms (SSPs) and/or demand-side platforms (DSPs). In general, the content platforms 130 can manage the selection and distribution of digital components on behalf of publishers and digital component providers. Some publishers use an SSP to manage the process of obtaining digital components for digital component slots of its resources and/or applications, e.g., for its electronic documents. An SSP is a technology platform implemented in hardware and/or software that automates the process of obtaining digital components for the resources and/or applications. Each publisher can have a corresponding SSP or multiple SSPs. Multiple publishers may use the same SSP.

A DSP is a technology platform implemented in hardware and/or software that automates the process of distributing digital components for presentation with the resources and/or applications. A DSP can interact with multiple supply-side platforms SSPs on behalf of digital component providers to provide digital components for presentation with the resources and/or applications of multiple different publishers. In general, a DSP can receive requests for digital components (e.g., from an SSP) and select one or more digital components created by one or more digital component providers based on the request, and provide data related to the digital components (e.g., the digital components itself and/or distribution parameters for the digital components) to an SSP. The SSP can then select one or more digital components and transmit data related to the digital components (e.g., a server request 121) to the client device 106.

As an example, when a user loads a web page or opens an application at a client device 106, a script of the web page or application can send a component request 112 to the SSP. The SSP can send a component request 112 (e.g., a modified version of the request 112 received from the client device 106) to one or more DSPs. Each DSP can implement the functionality of the service apparatus 110 to select one or more candidate digital components and distribution parameters for the digital components and provide this data to the SSP for use in selecting a digital component for display by the client device 106. In this example, both content platforms can perform selection functionality of the service apparatus 110 to select digital components in their respective stages. Thus, the service apparatus 110 can be considered a content platform and vice versa.

In general, the service apparatus 110 and/or content platforms are configured to select digital components that are relevant to the user, e.g., to satisfy the informational needs of the user. A proxy for relevance is the performance of the digital components. The performance of digital components can be measured in various ways. One example performance parameter for a digital component is an interaction rate, e.g., a click-through rate. An interaction rate measures the rate at which users interact with, e.g., click on or otherwise select, the digital components when displayed at the client devices 106 of the users.

Another performance metric for a digital component is a conversion rate. A conversion rate measures the rate at which users perform a specified action after viewing or interacting with a digital component. The specified actions can include, for example, the user purchasing an item that was the subject of the digital component, the user putting the item in a virtual shopping cart (e.g., with or without completing the purchase), visiting a particular resource (e.g., web page or application), downloading a mobile application (e.g., that is the subject of the digital component), downloading a file, sharing content (e.g., a web page), sharing the digital component with a contact, the user interacting with a click-to-call digital component and initiating the call to the number of the click-to-call digital component, and viewing a video. Each digital component can have one or more corresponding specified actions for which a conversion rate is measured.

The events related to digital components can also be referred to as network events. For example, presentation of a digital component, user interaction with a digital component, and performance of a specified action by the user following presentation of and/or interaction with the digital component are examples of network events for which network events are measured.

The secure network measurement system 140 is configured to determine and update network event measurements in a data secure and privacy preserving manner based on data received from components of the environment 100. For example, the secure network measurement system 140 can be configured to determine, as a network event measurement, a conversion rate for a digital component based on presentation data for the digital component and network event data for the digital component. Presentation data for the presentation of a digital component can include an encrypted identifier for a user to which the digital component was presented and data related to the presentation, as described in more detail below. The network event data can also include an encrypted identifier for a user that performed the specified action and data related to the specific action, as described in more detail below.

The identifiers can be encrypted using encryption keys (e.g., public keys) distributed by a key manager 160. The key manager 160 can also provide decryption keys (e.g., private keys corresponding to the public keys) that enable decryption of data encrypted using the private keys to the secure network measurement system 140 for use in decrypting the encrypted identifiers, correlating presentation and network event data for users, and determining the network event measurements using the correlated data.

The various components that report data for use in determining the network event measurements can send the data to measurement data storage 180. The measurement data storage 180 can include one or more data storage devices for storing presentation and network event data. The data can be stored in one or more databases, as described in more detail below.

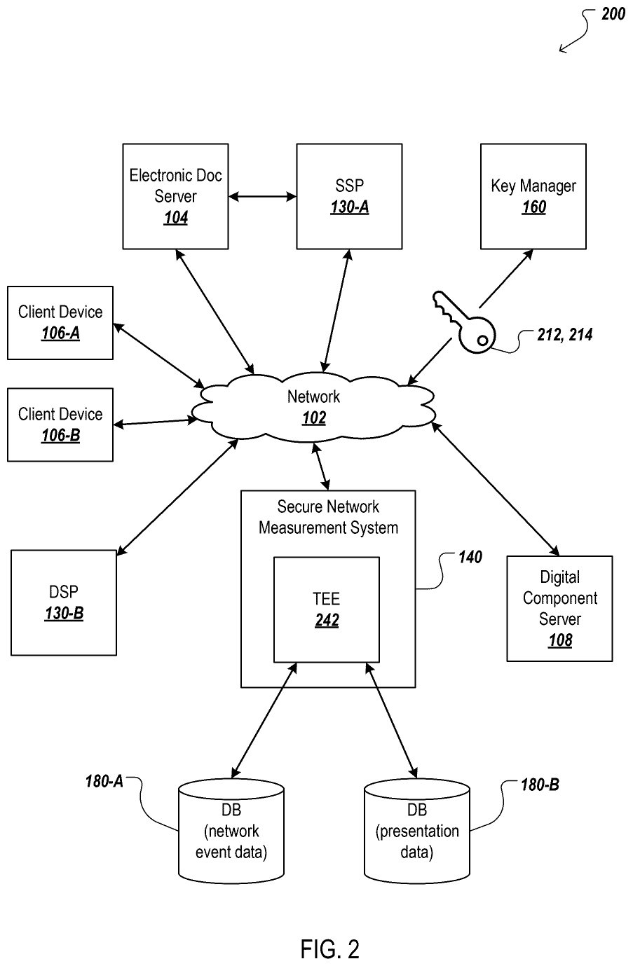

FIG. 2 is a block diagram 200 that illustrates some interactions between components of the environment of FIG. 1. In particular, FIG. 2 illustrates interactions between the components to report presentation event data and network event data and to determine network event measurements in privacy preserving ways.

The key manager 160 generates and distributes keys 212, 214 for encrypting or decrypting data communicated among other components. In the description that follows, public keys are used as examples of encryption keys and private keys are used as examples of decryption keys. However, other types of encryption and decryption keys can also be used.

The key manager 160 can distribute the public keys to components that encrypt data and send the corresponding private keys to the secure network measurement system 140 to enable the secure network management system 140 to decrypt the encrypted data. As described in more detail below, the secure network management system 140 includes a TEE 242 that can store the private keys and decrypt the encrypted data (e.g., encrypted identifiers) using the private keys such that the encrypted data is not accessible outside of the TEE 242 in cleartext. Cleartext is text that is not computationally tagged, specially formatted, or written in code, or data, including binary files, in a form that can be viewed or used without requiring a key or other decryption device, or other decryption process.

In an example, the key manager 160 can create a first public key 212-A and a second public key 212-B, collectively public keys 212. The key manager 160 can create a first private key 214-A and a second private key 214-B, collectively private keys 214. The key manager 160 can create a single public key 212 and a corresponding single private key 214. The key manager 160 sends, e.g., transmits, the public keys 212 and the private keys 214 over the network 102 to the various other components, as described elsewhere herein.

In general, the first public key 212-A and the corresponding first private key 214-A can be used to encrypt and decrypt identifiers of users for a first type of network event, e.g., presentation events. Similarly, the second public key 212-B and the corresponding second private key 214-B can be used to encrypt and decrypt identifiers of users for a second type of network event, e.g., interaction events or conversion events. The key manager 160 can send the first public key 212-A to the components that are responsible for reporting presentation event data, e.g., the client devices 106 that present digital components or the content platform 130 (e.g., SSP 130-A) that provides the digital components to the client devices 106 for presentation. Similarly, the key manager 160 can send the second public key 212-B to the components responsible for reporting conversion events, e.g., the electronic document server 104 of the digital component provider that provides the digital component for distribution to client devices 106. The key manager 160 provides the first private key 214-A and the second private key 214-B to the TEE 242.

In an example, the key manager 160 can send the first public key 212-A to the client devices 106 over the network 102. For example, each client device 106 can be configured to report presentation events with an encrypted identifier for the user of the client device 106. In another example, an SSP or a publisher's device can be configured to report the presentation events to the secure network measurement system 140 or to the database 180-B. In such examples, the key manager 160 can send the first public key to the SSP or publisher device to encrypt the identifier. In another example, the key manager 160 can send the public key to the client devices 106 and the client devices 106 can encrypt the identifier and provide the encrypted identifier to the SSP or publisher for reporting to the secure network measurement system 140 or to the database 180-B.

The key manager 160 can send the second public key 212-B to the DSPs 130-B over the network 102. In such examples, the DSPs 130-B can encrypt identifiers for users that perform specified actions and provide network event data that includes the encrypted identifier to the secure network measurement system 140 or to the database 180-A. In some implementations, the electronic document servers 104 of digital component providers and/or the client devices 106 can be configured to report network event measurement data. In such examples, the key manager 160 can provide the second public key 212-B to the electronic document servers 104 of the digital component providers and/or to the client devices 106. In another example, each client device 106 can be configured to encrypt the identifier using the second public key 212-B and provide the encrypted identifier to the electronic document server 104 of a digital component provider when a specified event occurs, or the user otherwise interacts with an electronic document hosted by the electronic document server 104 of the digital component provider. This enables the electronic document server 104 to report network event data with encrypted identifiers without having the second public key 212-B.

The key manager 160 can send the first private key 214-A (corresponding to the first public key 212-A) and the second private key 214-B (corresponding to the second public key 212-B) to the TEE 242 within the secure network measurement system 140.

Although in this example, a single encryption and decryption key pair is used for each type of network event, multiple key pairs can be used. For example, a public key and private key pair can be used for each digital component, each digital component provider, each publisher, and/or each user. The key manager 160 can provide the appropriate keys to each component.

The public keys 212-A and 212-B can be the same or different. Similarly, the private keys 214-A and 214-B can be the same or different. When the same, the encrypted identifier for a given user is the same for both types of network events. When different, the encrypted identifiers are also different due to the use of different encryption keys to encrypt the identifiers. Using different public keys 212-A and 212-B for the different network events can prevent entities from correlating data for users using the encrypted identifiers. Similarly, using different keys for different entities (e.g., different digital components, different digital component providers, and/or different publishers) also prevents such correlation by each entity having different encrypted identifiers for a given user. All private keys can be provided to the TEE 242 so that the TEE 242 can decrypt the identifiers and correlate the data for each identifier (and each user) within the secure environment of the TEE 242.

To further protect user privacy and enhance data security, the public keys 212 and private keys 214 can be rotated, e.g., periodically. That is, the key manager 160 can generate new keys and provide the new keys to the appropriate components, e.g., periodically based on a defined time period. This prevents the use of stable encrypted identifiers to track users over long periods of time.

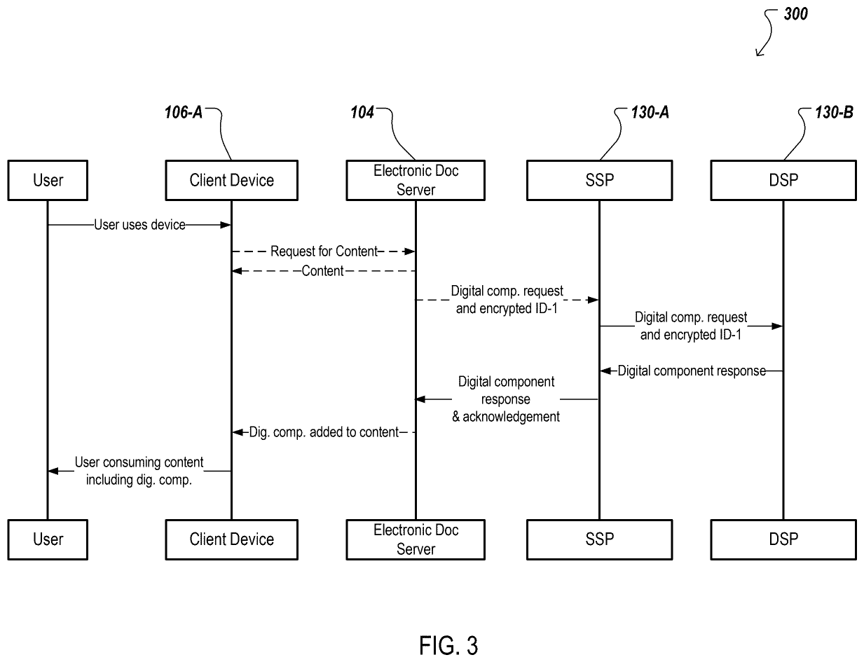

FIGS. 3 & 4 show examples of how the identifiers are encrypted and used to report presentation data and network event data to a presentation database 180-B and to a network event database 180-A, respectively, for use by the TEE 242 to determine and update network event measurements. In particular, these figures illustrate an example processes 300 and 400 in which the public keys 212 and private keys 214 are used by the various components to report presentation data and network event data and to determine network event measurements in ways that preserve user privacy and enhance data security. For ease of subsequent description, the network event measurement is a conversion rate for a digital component, but similar techniques can be used for other types of measurements.

Referring now to FIG. 3, the process 300 starts with a user interacting with a first client device 106-A to consume content. For example, the user can open a web browser and navigate to a website or open a mobile application. The client device 106-A requests the content from an electronic document server 104 of a publisher. In response, the electronic document server 104 (or client device 106-A, e.g., using a script in the electronic document provided by the electronic doc server) can send a component request (e.g., component request 112 described above) to request a digital component from an SSP 130-A (or the service apparatus 110 of FIG. 1).

Before sending the request to the SSP 130-A, either the client device 106-A or the electronic document server 104 can encrypt an identifier for the user with the first public key 212-A to generate an encrypted identifier (referred to as encrypted ID-1). An identifier of a client device 106 can be, for example, a name of the user or owner of the client device 106, a user identifier of a user logged into the client device 106, a phone number of the client device 106 (e.g., a mobile phone), an Internet Protocol (IP) address of the client device 106, a postal address associated with a client device 106, a location associated with an access point for the client device 106, a media access control (MAC) address of the client device 106, and the like.

The SSP 130-A can send the component request with encrypted ID-1 to one or more DSPs 130-B. As described elsewhere herein, each DSP 130-B can select candidate digital components based on the component request (e.g., based on the event data of the component request) and provide a digital component response that includes data for the candidate digital components to the SSP 130-B. The digital component response can include, for example, the candidate digital components, links or other references to the candidate digital components, and/or distribution parameters for the candidate digital components.

The SSP 130-A can select a digital component from candidate digital components received from each DSP 130-B and provide the digital component to the electronic document server 104. The electronic document server 104 can add the digital component to the content being provided to the client device 106-A for presentation to the user. In another example, if a script was used at the client device 106-A to request the digital component, the client device 106-A can receive the digital component and add the digital component being provided to the client device 106-A. The user of the client device 106-A can consume the requested content and the digital component at the client device 106.

In addition, the client device 106-A or another component (e.g., SSP 130-A or the electronic document server 104) can provide, to the presentation database 180-B, presentation data related to the presentation of the digital component to the user. The presentation data can include, for example, encrypted ID-1, data about the digital component presented to the user, and/or contextual data related to the presentation of the digital component to the user. The encrypted identifier encrypted ID-1 enables the TEE 242 to correlate presentation data with network event data, as described elsewhere herein.

The data about the digital component can include, for example, an identifier of the digital component (e.g., each digital component can have a unique identifier), the type of the digital component (e.g., audio file, video file, text file, etc.), an identifier of the content platforms (e.g., SSP 130-A and/or DSP 130-B) that participated in the distribution of the digital component to the client device 106-A, and/or other data related to the digital component.

The contextual data related to the presentation of the digital component can include a timestamp that indicates when the digital component was present at the client device 106-A, data about how the digital component was presented on the device (e.g., the size of the screen on which it was displayed or the speaker upon which the audio file was played), the type of the client device 106-A, the number of digital component slots in the content, and/or other data that describes the environment in which the digital component was presented.

The presentation database 180-B can store presentation data for multiple digital component presentations that occur at multiple client devices 106. The TEE 242 can access this presentation to determine network event measurements, as described elsewhere herein.

After viewing the digital component, the user may later perform a specified action for the digital component using the client device 106-A or another client device 106-B different from the client device 106-A. The techniques described in this document enable the correlation of presentation data for a user view of a digital component at one device with network event data for a specified action made by the user at a different device, which can be considered a cross-device correlation or measurement. For example, a user can play a game on their phone and a digital component can be presented to the user while the user plays the game. This digital component can include content about an item with which the user may be interested based on their interaction with the game. Later, the user can access a website related to that item and purchase the item, which can be the specified action. The techniques also enables the correlation of presentation data for a user view of a digital component at one domain or using one mobile app with network event data for a specified action made by the user at a different domain or using a different mobile app, which can be considered a cross-domain correlation or measurement.

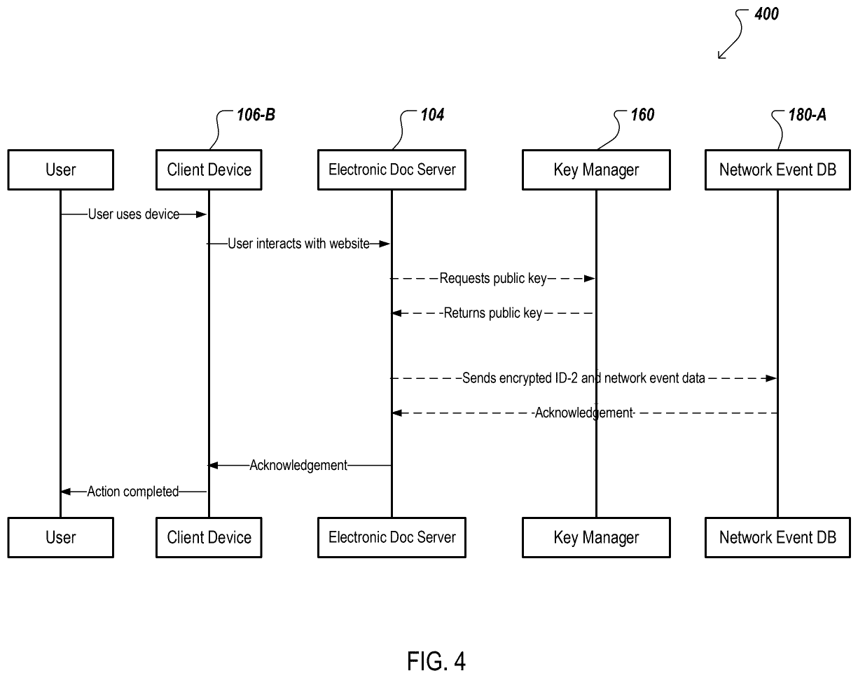

Referring now to FIG. 4, the process starts with a user using a client device 106-B to interact with a website. The client device 106-B can be the same device as the client device 106-A or a different device. For example, the website can include a landing page linked to by the digital component presented at the client device 106-A. While interacting with the website, the user performs a specified action for the digital component (e.g., adds an item to a virtual shopping cart). The electronic document server 104 can be configured to detect network events (e.g., specified actions for digital components) and report network event information for the detected network events to the network event database 180-A. For example, the electronic document server 104 for a digital component provider can store data indicating specified actions for items or services and use this data to detect when a specified action has occurred.

In response to detecting a network event, the electronic document server 104 can send a request for the second public key 212-B from the key manager 160. The key manager 160 provides the second public key 212-B to the electronic document server 104 in response to the request. The electronic document server 104 can store the second public key 212-B from a prior request for a key from the key manager 160. In this way, the electronic document server 104 does not have to request the key each time a network event is detected.

The electronic document server 104 encrypts the identifier of the user of the client device 106-B using the second public key 212-B and sends network event data that includes the encrypted identifier (encrypted ID-2) to the network event database 180-A. The network event database 180-A can respond with an acknowledgement to the electronic document server 104. Additionally, the electronic document server 104 sends another acknowledgement to the client device 106-B. The client device 106 notifies the user that the action has been completed. During this process 400, the user can continue using the client device 106-B without interruption.

In addition to the encrypted identifier (encrypted ID-2), the network event data about the network event can include, for example, a time stamp that indicates a time at which the network event occurred. The network event data can include data indicating a physical location of, for example, a server on which the network event occurred. The network event data can include a uniform resource locator (URL) or the website or Internet address on which the network event occurred. The network event data can include a description of the network event (e.g., the item placed in a shopping basket, a photo flagged for additional inspection).

In some implementations, the client device 106-B can encrypt the identifier of the user and/or report the network event data to the database 180-A. For example, the landing page can request the encrypted identifier from the client device 106-B in response to the user navigating to the landing page. When the electronic document server 104 detects the specified action, the electronic document server 104 can send the network event data including the received encrypted identifier to the database 180-A. This enables the electronic document server 104 to report conversions while limiting the number of entities that receive the public key used to encrypt the identifier and enabling the client device 106-B to only send an encrypted version of the identifier off of the client device 106-B, which enhances user privacy.

In another example, the client device 106-B can report the network event data. For example, the electronic document server 104 can detect the specified action and request that the client device 106 send the network event data to the database 180-A.

Referring back to FIG. 2, the TEE 242 can access the presentation data and network event data stored in the presentation database 180-B and the network event database 180-A to determine network event measurements for digital components.

In some implementations, the presentation data and the network event data can also be encrypted. For example, the entity that reports the data can encrypt the data using a public key (e.g., received from the key manager 160) and the TEE 242 can decrypt the data using a corresponding private key (e.g., received from the key manager 160). For case of description, the remainder of the disclosure does not discuss the details of encryption of the presentation data and the network event data.

In some implementations, the TEE 242 has already received the first private key 214-A and the second private key 214-B from the key manager 160. In some implementations, the TEE 242 has already received the single private key 214 from the key manager 160.

The TEE 242 correlates, e.g., matches, the received information from the presentation database 180-B with information from the network event database 180-A to associate the network event with the presentation of a digital component. That is, the TEE 242 identifies, for each network event (e.g., each occurrence of a specified action for which network event data was stored in the network event database 180-A), zero or more presentations of a digital component presented to the same user as the user that performed the network event for which presentation data was stored in the presentation database 180-B.

In some implementations, the TEE 242 decrypts the identifiers of the presentation data received from the presentation database 180-B using the first private key 214-A corresponding to the presentation data (they all may be the same or different as described above) and decrypts the identifiers of the network event data received from the network event database 180-A using the second private key 214-B corresponding to the network data (they all may be the same or different as described above).

For example, as described above, the key manager 160 can generate a public/private key pair for each digital component provider. In this example, the TEE 242 can identify, in the network event data, the identifier for the digital component or digital component provider and obtain the private keys for the digital component or digital component provider. The TEE 242 can then decrypt the identifiers of presentation data for the digital component or digital component provider using the first private key 214-A for the digital component or digital component provider and decrypt the identifiers of the network event data for the digital component or digital component provider using the second private key 214-B for the digital component or digital component provider.

For each network event, the TEE 242 can decrypt the identifier using the appropriate private key 214-B and compare the decrypted identifier to decrypted identifiers of presentation data for the same digital component or digital component provider. For example, the TEE 242 can attempt to identify, for a network event corresponding to a digital component, whether the digital component was presented to the user and, if so, identify the presentation data for each presentation of the digital component to the user.

Matching the presentation of a digital component with a network event can include, for example, similarity calculations comparing data associated with the presentation of a digital component with data associated with the network event. In addition, there may be multiple presentations of multiple digital components on a first client device and also multiple network events on a second client device requiring matching.

In some cases, multiple digital components for an item are presented to a user prior to a network event occurring. The TEE 242 can use the encrypted identifiers and digital component identifiers to match presentation events for a user and the digital component with the network event data for the network event corresponding to the user and digital component. As an example, the TEE 242 can identify, for a given user, a network event having a given digital component identifier that identifies a given digital component. The TEE 242 can evaluate the presentation data for the given user to identify each presentation of that digital component, if any, to the given user based on the given digital component identifier being included in the presentation data for the given user.

The multiple digital component presentations could also result from multiple content platforms participating in the process of presenting the multiple digital components to the user. For example, a first SSP or DSP may select the digital component for presentation to the user at time A and a second SSP or DSP may select the same digital component for presentation to the user at time B. In such cases, the TEE 242 can be configured (e.g., with logic, algorithms, or rules) to attribute credit for the network event to one or more of the content platforms. For example, the second SSP or DSP may be awarded more attribution credit due to the more recent presentation of the digital component than the first SSP or DSP. Various attribution models can be used to attribute credits among multiple content platforms.

In another example, the TEE 242 can use a trained model, e.g., a trained machine learning model, to attribute credit for the network event to one or more of the content platforms 130. In another example, a first DSP can present a first digital component multiple times and a second DSP can present a second, but related, digital component a single time. The TEE 242 can attribute credit to the first DSP and the second DSP based on the number of times each digital component was presented. In another example, the TEE 242 can attribute credit to the first and the second DSPs based on a similarity calculation between the digital component and the network event.

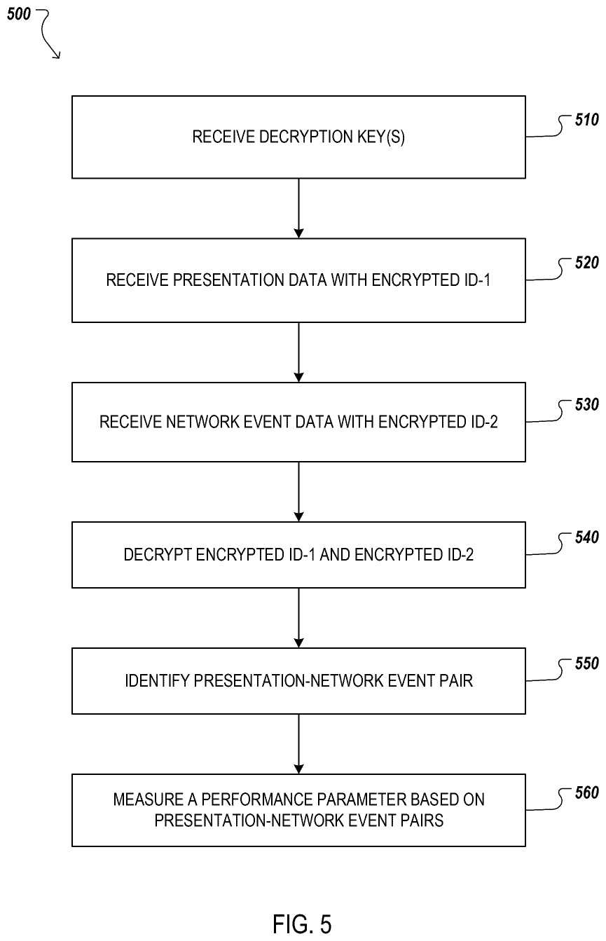

FIG. 5 a flow chart of an example process 500 of measuring network event data for digital components. Operations of the process 500 can be implemented, for example, by the secure network measurement system 140, e.g., by the TEE 242, of FIGS. 1 and 2. Operations of the process 500 can also be implemented as instructions stored on one or more computer readable media which may be non-transitory, and execution of the instructions by one or more data processing apparatus can cause the one or more data processing apparatus to perform the operations of the process 500.

The TEE 242 receives decryption keys for decrypting encrypted identifiers (510). A key manager 160 can produce pairs of public keys and private keys for encrypting data. In some implementations, the key manager 160 produces a first public key 212-A and a corresponding first private key 214-A. The key manager 160 sends, e.g., transmits across a network, the first public key 212-A to entities, e.g., the client devices 106, that encrypt identifiers for reporting presentation data. The entities can be configured to encrypt identifiers for users using the first public key 212-A and send presentation data that includes the encrypted identifier and other data to the presentation database 180-B in response to presentations of digital components at the client devices 106 of the users.

Similarly, the key manager 160 produces a second public key 212-B and a corresponding second private key 214-B. The key manager 160 sends, e.g., transmits, the second public key 212-B to entities, e.g., client devices 106 or electronic document servers 104, that encrypt identifiers for reporting network event data. The entities can be configured to encrypt identifiers for users using the second public key 212-B and send network data that includes the encrypted identifier and other data to the network event database 180-A in response to detecting the network events for the users.

The key manager 160 sends, e.g., transmits, the first private key 214-A and the second private key 214-B to the TEE 242. The TEE 242 receives the first private key 214-A and the second private key 214-B from the key manager 160.

In some implementations, the key manager 160 produces a single public key 212 and a single private key 214. In such embodiments, the key manager 160 transmits the single public key 212 to the entities that report presentation data. In such implementations, the key manager 160 transmits to the TEE 242 the single private key 214.

The TEE 242 receives presentation data that includes an encrypted identifier (520). The TEE 242 can receive, from the presentation database 180-B, presentation data that includes the identifier which has been encrypted using the first public key 212-A and data relating to the digital component displayed at the client device 106. These two sets of data are correlated so that the identifier encrypted with the first public key is associated with a particular impression on the client device 106. The identifier encrypted with the first public key 212-A can be referred to as encrypted identifier-1 or encrypted ID-1. The presentation database 180-B can store many individual encrypted identifiers and data associated with many impressions; each impression associated with a single encrypted identifier-1 corresponding to the user to which the digital component was presented.

The TEE 242 can receive the presentation data from a first device. This first device can be a client device 106 at which the digital component was displayed to the user. In another example, the first device can be an SSP or publisher that provided the digital component to the client device 106 for presentation to the user. In some implementations, the TEE 242 can receive the presentation data from the first device by way of a database 180-B that stores presentation data for the TEE 242.

The TEE 242 receives network event data (530). The TEE 242 receives network event data that includes the identifier which has been encrypted using the second public key 212-B and data relating to a network event between the client device 106 and a content platform 130. These two sets of data are correlated so that the identifier encrypted with the second public key is associated with a particular network event of the client device 106. The identifier encrypted with the second public key 212-B may be referred to as encrypted identifier-2 or encrypted ID-2.

The TEE 242 can receive the network event data from a second device. The second device can be an electronic document server 104 of the digital component provider that provides the digital component. For example, the electronic document server can detect a specified event and provide the network event data to the TEE 242 or to a network event database 180-A in response to detecting the event. The network event database 180-A can store many individual, encrypted identifiers and data associated with many network events; each individual network event associated with a single encrypted identifier-2.

In another example, the second device can be a client device 106 of the user. This client device 106 can be the same one at which the digital component was presented or a different client device 106 of the user. For example, the user may view a digital component on their phone and later visit the landing page linked to by the digital component on a computer.

The presentation data and network event data received by the TEE 242 in operations (520) and (530) can include many instances of presentation event data and many instances of network event data for many different users.

In some implementations, the TEE 242 decrypts each identifier received from the presentation database 180-B using the first private key 214-A and also decrypts each identifier received from the network event database 180-A using the second private key 214-B.

In implementations in which the first public key 212-A and the second public key 212-B are the same, then there is a single public key 212 and a single private key 214. In some such implementations, the TEE 242 can use the single private key 214 to decrypt the identifier from the presentation database 180-B and can also use the single private key 214 to decrypt the identifier from the network event database 180-A.

The TEE 242 matches the presentation data for the presentation of the digital component with the network event data for the network event (550). TEE 242 has decrypted the identifier of the presentation data and the identifier of the network event data. The TEE 242 can compare the decrypted identifiers to determine whether they match. If so, the TEE 242 assigns as a matched pair the presentation data with the network event data. The TEE 242 can also store the matched pair in a database (e.g., an attributed network event-presentation database) without further storing or transmitting the decrypted identifiers.

In some implementations, the TEE 242 can perform the matching by using a similarity calculation between ID-1 and ID-2. If the similarity result is greater than a first threshold value, then the TEE 242 assigns as a matched pair the presentation data associated with ID-1 with the network event data associated with ID-2. If the similarity result is between the first threshold value and a second threshold value, then the TEE 242 can assign as a potentially matched pair the presentation data associated with ID-1 with the network event data associated with ID-2. If the similarity result is below the second threshold value, then the presentation data is not matched with the network event data.

In some implementations, matching and associating the network event with the presentation of a digital component can also include assigning a weight to multiple digital component presentations associated with a single network event. For example, at a first time multiple digital components can be presented on a client device 106. At a second time after the first time, a network event occurs on a client device 106. Each of the presentations of digital components at the first time can be associated with the network event. The matching can include a requirement that the presentation of the digital component occurs before the network event, based on a timestamp of each presentation and a time stamp of the network event. In such matching, multiple similarity calculations can be used including similarity calculations between the data associated with network events and the data associated with each of the multiple presentations. In an example, an embedding of the presentation data and an embedding of the network event can be used in a similarity calculation to assign the weighting of the presentation with the network event.

In addition, a client device 106 may have provided multiple digital component presentations related to a disparity of topics. As part of matching the presentation with the network event, a matching must also occur so that the presentation of the digital components which are most relevant to the network event are attributed to that network event and that less relevant digital components are not incorrectly attributed to the network event. For example, a user may watch a sporting event on a family entertainment system. The following day the user may book a hotel stay on a laptop computer. During the sporting event viewing the user may have been presented with multiple digital components; however, only some of the presented digital components may be related to the hotel booking, whereas others may be irrelevant or less relevant. The matching of a presentation of a digital component with a network event can include a similarity calculation between the types of digital components presented and the type of network event. The data associated with the digital components can include, for example, data related to a location, a theme, a product, an experience, etc. An example similarity calculation is a cosine similarity between an embedding of the presentation data with an embedding of the network event data.

In an example, the data associated with the presentations of digital components can include an identifier for each digital component and a time stamp for each presentation. The data associated with the network event can also include a timestamp. The similarity calculation can include a different weight depending on the timestamps of the presentation and of the network event. For example, more recent presentations can be weighted more heavily.

The TEE 242 can store each matched presentation-network event pair in a third database. The TEE 242 does not transmit either ID-1 or ID-2 to the third database nor does the TEE 242 store either ID-1 or ID-2. This third database can be called the attributed network event database since it attributes the network event on the client device 106 to a matched presentation of a digital component on the client device 106. The attribution database can be accessible by other parties who would have no access to the identifiers associated with a client device 106.

The TEE 242 determines a network event measurement based on matched presentation-network event pairs (560). For example, the TEE 242 can determine, as the network event measurement, a conversion rate for a digital component based on a number of times the digital component was presented to users and the number of times that the specified event occurred following presentation of the digital component. To do so, the TEE 242 can calculate the number of times the digital component was presented based on the presentation data stored in the presentation database 180-B. For example, the TEE 242 can determine the number of times a digital component was presented based on the number of individual pieces of presentation data are stored for the digital component.

The TEE 242 can also calculate the number of presentation-network event pairs for the digital component. The conversion rate can be a ratio between the number of times the digital component was presented and the number of presentation-network event pairs for the digital component. The measurements can be determined for various time periods, e.g., using the presentation data and network event data for each time period.

In some implementations, the TEE 242 can determine a conversion rate based on interactions with (e.g., selections of) digital components. In this example, interaction events can be reported in the same manner as presentation events and interaction counts can be used in place of presentation counts.

In another example, the TEE 242 can determine an interaction rate for a digital component based on the number of presentations of the digital component (e.g., the number of distinct pieces of presentation data that identifies the digital component) and the number of interactions with the digital component (e.g., the distinct pieces of number network event data that references an interaction with the digital component).

Any number of network event measurements can be determined once the identifiers are decrypted such that events can be correlated with the same user. In short, by using this method and system, the TEE 242 ensures that the assignment of a presentation of a digital component with a network event has properly occurred without permitting a third-party access to any identifiers in cleartext at all.

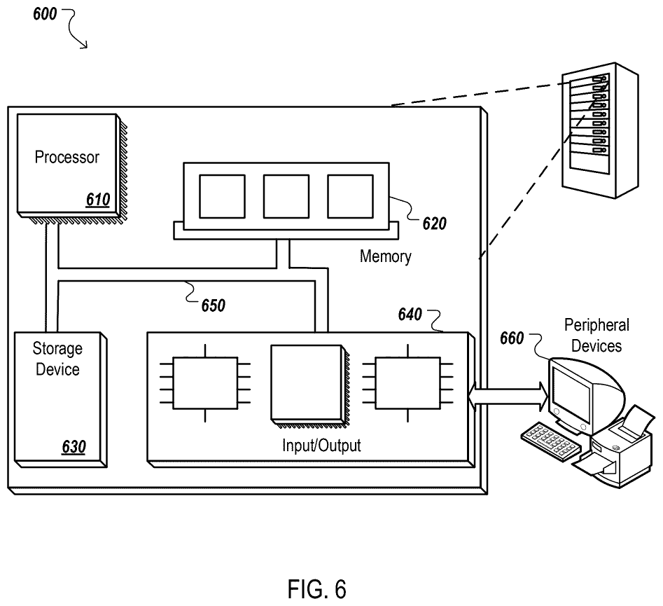

FIG. 6 is a block diagram of an example electronic device 600 that can be used to perform operations described above. The electronic device 600 includes a processor 610, a memory 620, a storage device 630, and an input/output device 640. Each of the components 610, 620, 630, and 640 can be interconnected, for example, using a system bus 650. The processor 610 is capable of processing instructions for execution within the electronic device 600. In one implementation, the processor 610 is a single-threaded processor. In another implementation, the processor 610 is a multi-threaded processor. The processor 610 is capable of processing instructions stored in the memory 620 or on the storage device 630.

The memory 620 stores information within the electronic device 600. In one implementation, the memory 620 is a computer-readable medium. In one implementation, the memory 620 is a volatile memory unit. In another implementation, the memory 620 is a non-volatile memory unit.

The storage device 630 is capable of providing mass storage for the electronic device 600. In one implementation, the storage device 630 is a computer-readable medium. In various different implementations, the storage device 630 can include, for example, a hard disk device, an optical disk device, a storage device that is shared over a network by multiple computing devices (e.g., a cloud storage device), or some other large capacity storage device.

The input/output device 640 provides input/output operations for the electronic device 600. In one implementation, the input/output device 640 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other devices, e.g., keyboard, printer, display, and other peripheral devices 660. Other implementations, however, can also be used, such as mobile computing devices, mobile communication devices, set-top box television client devices, etc.

Although an example processing system has been described in FIG. 6, implementations of the subject matter and the functional operations described in this specification can be implemented in other types of digital electronic circuitry, or in computer software, firmware, or hardware, including the structures disclosed in this specification and their structural equivalents, or in combinations of one or more of them.

An electronic document (which for brevity will simply be referred to as a document) does not necessarily correspond to a file. A document may be stored in a portion of a file that holds other documents, in a single file dedicated to the document in question, or in multiple coordinated files.

For situations in which the systems discussed here collect and/or use personal information about users, the users may be provided with an opportunity to enable/disable or control programs or features that may collect and/or use personal information (e.g., information about a user's social network, social actions or activities, a user's preferences, or a user's current location). In addition, certain data may be treated in one or more ways before it is stored or used, so that personally identifiable information associated with the user is removed. For example, a user's identity may be anonymized so that the no personally identifiable information can be determined for the user, or a user's geographic location may be generalized where location information is obtained (such as to a city, ZIP code, or state level), so that a particular location of a user cannot be determined.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

This document refers to a service apparatus. As used herein, a service apparatus is one or more data processing apparatus that perform operations to facilitate the distribution of content over a network. The service apparatus is depicted as a single block in block diagrams. However, while the service apparatus could be a single device or single set of devices, this disclosure contemplates that the service apparatus could also be a group of devices, or even multiple different systems that communicate in order to provide various content to client devices. For example, the service apparatus could encompass one or more of a search system, a video streaming service, an audio streaming service, an email service, a navigation service, an advertising service, a gaming service, or any other service.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random-access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method comprising:
receiving, by a secure network measurement system comprising a trusted execution environment (TEE) and from a first device, presentation data for a presentation of a digital component at the first device, the presentation data comprising an encrypted first identifier, wherein the encrypted first identifier is generated by encrypting a first identifier that identifies a user of the first device using a first encryption key;
receiving, by the secure network measurement system and from a second device, network event data sent in response to a user of the second device performing a specified action following the presentation of the digital component at the first device, the network event data comprising an encrypted second identifier, wherein the encrypted second identifier is generated by encrypting a second identifier that identifies the user of the second device using a second encryption key;
matching, within the TEE, the presentation data with the network event data to form a presentation-network event pair; and
determining a network event measurement for the digital component based on a plurality of presentation-network event pairs including a presentation-network event pair stored in a database.

2. The method of claim 1, wherein the first encryption key is different from the second encryption key.

3. The method of claim 2, further comprising receiving, from a key generator, a first decryption key for decrypting data encrypted using the first encryption key and a second decryption key for decrypting data encrypted using the second encryption key.

4. The method of claim 3, further comprising:
decrypting the first identifier with the first decryption key; and
decrypting the second identifier with the second decryption key,
wherein matching is based on a comparison of the first identifier with the second identifier.

5. The method of claim 1, wherein the second encryption key is the same as the first encryption key.

6. The method of claim 5, further comprising, receiving from a key generator, a decryption key associated with the first encryption key.

7. The method of claim 6, further comprising:
decrypting the first identifier and the second identifier with the decryption key,
wherein matching the presentation data with the network event data is based on a comparison of the first identifier with the second identifier.

8. The method of claim 1, wherein the first identifier or the second identifier comprises at least one of a user identifier, an email address, physical address, a postal address, a MAC address of the first device, or an IP address associated with the first device.

9. A secure network measurement system comprising:
a trusted execution environment (TEE) comprising one or more processors and instructions that, when executed by the one or more processors, cause the one or more processors to perform operations comprising:
receiving, from a first device, presentation data for a presentation of a digital component at the first device, the presentation data comprising an encrypted first identifier, wherein the encrypted first identifier is generated by encrypting a first identifier that identifies a user of the first device using a first encryption key;
receiving, from a second device, network event data sent in response to a user of the second device performing a specified action following the presentation of the digital component at the first device, the network event data comprising an encrypted second identifier, wherein the encrypted second identifier is generated by encrypting a second identifier that identifies the user of the second device using a second encryption key;
matching, within the TEE, the presentation data with the network event data to form a presentation-network event pair; and
determining a network event measurement for the digital component based on a plurality of presentation-network event pairs including a presentation-network event pair stored in a database.

10. The system of claim 9, wherein the first encryption key is different from the second encryption key.

11. The system of claim 10, wherein the operations comprise receiving, from a key generator, a first decryption key for decrypting data encrypted using the first encryption key and a second decryption key for decrypting data encrypted using the second encryption key.

12. The system of claim 11, wherein the operations comprise:
decrypting the first identifier with the first decryption key; and
decrypting the second identifier with the second decryption key,
wherein matching is based on a comparison of the first identifier with the second identifier.

13. The system of claim 9, wherein the second encryption key is the same as the first encryption key.

14. The system of claim 13, wherein the operations comprise receiving from a key generator, a decryption key associated with the first encryption key.

15. The system of claim 14, wherein the operations comprise:
decrypting the first identifier and the second identifier with the decryption key, wherein matching the presentation data with the network event data is based on a comparison of the first identifier with the second identifier.

16. The system of claim 9, wherein the first identifier or the second identifier comprises at least one of a user identifier, an email address, physical address, a postal address, a MAC address of the first device, or an IP address associated with the first device.

17. A non-transitory computer readable medium storing instructions that, when executed by one or more processors, cause a secure network measurement system comprising a trusted execution environment (TEE) to execute operations, the operations comprising:
receiving, from a first device, presentation data for a presentation of a digital component at the first device, the presentation data comprising an encrypted first identifier, wherein the encrypted first identifier is generated by encrypting a first identifier that identifies a user of the first device using a first encryption key;
receiving, from a second device, network event data sent in response to a user of the second device performing a specified action following the presentation of the digital component at the first device, the network event data comprising an encrypted second identifier, wherein the encrypted second identifier is generated by encrypting a second identifier that identifies the user of the second device using a second encryption key;
matching, within the TEE, the presentation data with the network event data to form a presentation-network event pair; and
determining a network event measurement for the digital component based on a plurality of presentation-network event pairs including a presentation-network event pair stored in a database.

18. The non-transitory computer readable medium of claim 17, wherein the operations comprise:
receiving, from a key generator, a first decryption key for decrypting data encrypted using the first encryption key and a second decryption key for decrypting data encrypted using the second encryption key;
decrypting the first identifier with the first decryption key; and
decrypting the second identifier with the second decryption key,
wherein the first encryption key is different from the second encryption key, and
wherein matching is based on a comparison of the first identifier with the second identifier.

19. The non-transitory computer readable medium of claim 17, wherein the operations comprise receiving, from a key generator, a first decryption key for decrypting data encrypted using the first encryption key and a second decryption key for decrypting data encrypted using the second encryption key.

20. The non-transitory computer readable medium of claim 19, wherein the operations comprise:
decrypting the first identifier with the first decryption key; and
decrypting the second identifier with the second decryption key,
wherein matching is based on a comparison of the first identifier with the second identifier.
